(19) United States
(12) Patent Application Publication
(10) Pub. No.: US 2022/0343264 A1
(43) Pub. Date: Oct. 27, 2022

(54) Operating Method for Electronic Apparatus for Offering Information Related to Order and Electronic Apparatus Supporting Thereof

(71) Applicant: Coupang Corp., Seoul (KR)

(72) Inventors: Wei Wei, Seoul (KR); Ke Ma, Seoul (KR); Xiukun Liang, Seoul (KR); Guangyao Zhang, Seoul (KR); Kai Zhang, Seoul (KR); Soo Kyung Choi, Seoul (KR); Timothy Wolfgang Schoenharl, Seoul (KR)

(73) Assignee: Coupang Corp., Seoul (KR)

(21) Appl. No.: 17/406,783

(22) Filed: Aug. 19, 2021

(30) Foreign Application Priority Data
Apr. 26, 2021 (KR) 10-2021-0053763

(51) Int. Cl. G06Q 10/08; G06Q 10/06; G06Q 30/02

(52) U.S. Cl. CPC G06Q 10/087; G06Q 10/06315; G06Q 10/06312; G06Q 30/0201; G06Q 30/0635

(57) ABSTRACT

Disclosed is a method of providing information related to an order by an electronic apparatus, the method including acquiring necessary order information including information on at least one order item, information on an order quantity of the at least one order item, and information on a lead time of the at least one order item, confirming a reference date based on the information on the lead time, confirming information on a remaining storage capacity of a fulfillment center on the reference date, confirming a target order item whose order quantity is to be adjusted from the necessary order information when order quantity corresponding to the necessary order information exceeds the remaining storage capacity of the fulfillment center on the reference date, and providing updated order information in which the order quantity of the target order item is adjusted.

### RELATED APPLICATION INFORMATION

The present application claims priority to and the benefit of Korean Patent Application No. 10-2021-0053763 filed on Apr. 26, 2021, and is incorporated by reference herein in its entirety.

### TECHNICAL FIELD

The following descriptions relate to a method and apparatus for providing information related to an order, and more particularly, to a method of providing information including an order quantity of items updated so as not to exceed a remaining storage capacity of a fulfillment center and an electronic apparatus for the method.

### DESCRIPTION OF THE RELATED ART

With the development of electronic technology, e-commerce has become a field of shopping. Customers can purchase items online without going to a shopping mall or a market in person, and the items purchased online are delivered to delivery addresses designated by the customers.

A logistics information management system for such an e-commerce service can operate a plurality of fulfillment centers and manage information on each of the fulfillment centers for more effective service provision. For example, when an order request for items occurs, the logistics information management system may determine the fulfillment center which will process the order in consideration of characteristics of the order (e.g., a delivery address and inventory in the fulfillment centers) and allocate the order to the determined fulfillment center.

In this regard, documents of related art such as KR100932262B1 may be consulted.

### DISCLOSURE OF THE INVENTION

### Technical Goals

According to a method of the present disclosure, an electronic apparatus for providing information related to an order provides information including an order quantity of items, which is updated not to exceed a remaining storage capacity of a fulfillment center, to increase the convenience of managing the fulfillment center.

Technical goals of the present disclosure are not limited to those described above, and other technical goals which have not been described may be clearly understood by those of ordinary skill in the art from the following descriptions.

### Technical Solutions

Various example embodiments may provide an operating method of an electronic apparatus for providing information related to an order and an electronic apparatus which supports the operating method.

According to various example embodiments, a method of providing information related to an order by an electronic apparatus includes acquiring necessary order information including information on at least one order item, information on an order quantity of the at least one order item, and information on a lead time of the at least one order item, confirming a reference date based on the information on the lead time, confirming information on a remaining storage capacity of a fulfillment center on the reference date, confirming a target order item whose order quantity is to be adjusted from the necessary order information when order quantity corresponding to the necessary order information exceeds the remaining storage capacity of the fulfillment center on the reference date, and providing updated order information in which the order quantity of the target order item is adjusted.

In an example embodiment, the information on the remaining storage capacity may be confirmed based on information on an item storage capacity of the fulfillment center, information on a current amount of inventory in the fulfillment center, and information on a scheduled warehousing quantity of the fulfillment center according to existing orders.

In an example embodiment, the information on the remaining storage capacity may be confirmed based on estimated release quantity information by the reference date.

In an example embodiment, the confirming of the information on the remaining storage capacity may include confirming a storage type corresponding to the at least one order item based on the information on the at least one order item and confirming information on a remaining storage capacity of a storage place corresponding to the storage type in the fulfillment center.

In an example embodiment, the confirming of the target order item whose order quantity is to be adjusted from the necessary order information may include confirming the target order item whose order quantity is to be adjusted based on priority information included in the information on the at least one order item.

In an example embodiment, the priority information may include information on a first group having a high priority, a second group having a medium priority, and a third group having a low priority. The first group may include order items to which a price discount is applied among the at least one order item, the second group may include some order items having a high priority among remaining order items excluding the first group, and the third group may include remaining order items excluding the first group and the second group.

In an example embodiment, the confirming of the target order item whose order quantity is to be adjusted based on the priority information may include confirming a target order item of a target group whose order quantity is to be adjusted in ascending order of priority according to an excessive order quantity calculated by comparing the order quantity corresponding to the necessary order information with the remaining storage capacity of the fulfillment center.

In an example embodiment, the target order item may include order items of the third group.

In an example embodiment, the order items of the third group included in the target order item may include order items for basic stock and order items for safety stock.

In an example embodiment, the order items of the third group included in the target order item may be determined based on sales volume.

In an example embodiment, when the excessive order quantity is larger than order quantity which is adjustable for the order items of the third group, the target order item may further include order items of the second group.

In an example embodiment, the order items of the second group included in the target order item may include order items for basic stock and order items for safety stock.

In an example embodiment, the order items of the second group included in the target order item may be determined based on sales volume.

In an example embodiment, when the excessive order quantity is larger than order quantity which is adjustable for the order items of the second group and the third group, the target order item may further include order items of the first group.

In an example embodiment, the order items of the first group included in the target order item may include order items for basic stock and order items for safety stock.

In an example embodiment, the order items of the first group included in the target order item may be determined based on sales volume.

In an example embodiment, the method may further include acquiring change information of the remaining storage capacity, and when the remaining storage capacity is increased according to the change information, confirming a group and an order item to be reordered among the confirmed group and the confirmed order item whose order quantity is adjusted in descending order of priority according to the increased remaining storage capacity.

According to various example embodiments, an electronic apparatus for providing information related to an order includes a processor and one or more memories configured to store one or more instructions. When the one or more instructions are executed, the one or more instructions may control the processor to perform operations of acquiring necessary order information including information on at least one order item, information on an order quantity of the at least one order item, and information on a lead time of the at least one order item, confirming a reference date based on the information on the lead time, confirming information on a remaining storage capacity of a fulfillment center on the reference date, confirming a target order item whose order quantity is to be adjusted from the necessary order information when order quantity corresponding to the necessary order information exceeds the remaining storage capacity of the fulfillment center on the reference date, and providing updated order information in which the order quantity of the target order item is adjusted.

The above-described various example embodiments of the present disclosure are only some of example embodiments of the present disclosure, and various example embodiments reflecting technical characteristics of the present disclosure may be derived and understood from the following detailed description by those of ordinary skill in the art.

### Effects

The present disclosure proposes a method of providing information including an order quantity of items, which is updated not to exceed a remaining storage capacity of a fulfillment center. Accordingly, the present disclosure has technical effects in terms of facilitating management of a fulfillment center.

Effects obtainable from the present disclosure are not limited to those described above, and other effects which have not been described will be clearly understood from the following descriptions by those of ordinary skill in the art.

### BRIEF DESCRIPTION OF THE DRAWINGS

FIG. 1 is a diagram illustrating an order-related information providing system in which an operating method of an electronic apparatus for providing information related to an order may be implemented according to various example embodiments.

FIG. 2 is a diagram illustrating a configuration of a server device and a device interoperating with the server device according to various example embodiments.

FIG. 3 is a flowchart illustrating an operating method of an electronic apparatus for providing information related to an order according to various example embodiments.

FIG. 4 is a diagram illustrating an example of a flowchart in which a server device 100 adjusts an order quantity for each group of order items according to an excessive order quantity and updates order information on the basis of the adjusted order quantity according to various example embodiments.

FIGS. 5A and 5B are diagrams illustrating an example in which the server device 100 or a device 200 interoperating with the server device 100 outputs updated order information according to various example embodiments.

### DETAILED DESCRIPTION FOR CARRYING OUT THE INVENTION

The following example embodiments are provided by combining components and features of the present disclosure in specific forms. The components or features may be considered optional unless explicitly stated otherwise. The components or features may be implemented without being combined with other components or features. Various example embodiments of the present disclosure may be provided by combining some of the components and features. The order of operations described in the various embodiments may be changed. Some components or features of an example embodiment may be included in another example embodiment or may be replaced with corresponding components or features of another example embodiment.

In the following description of drawings, procedures or operations that may obscure the gist of various example embodiments are not described, and procedures or operations apparent to those of ordinary skill in the art are not described either.

Throughout the specification, when a part is referred to as “comprising” or “including” a component, this indicates that the part may further include another component, and other components are not excluded unless particularly stated otherwise. Terms such as “part,” “-ed/-or,” and “module,” used in the specification refer to a unit which performs at least one function or operation and may be implemented in hardware, software, or a combination of hardware and software. Also, “a” or “an,” “one,” “the,” and words similar thereto may be used to include both the singular and the plural unless indicated otherwise in the context of various example embodiments (particularly in the context of the claims) or the context clearly prevents such an interpretation.

Hereinafter, example embodiments of the present disclosure will be described in detail with reference to the accompanying drawings. The detailed description set forth herein in connection with the accompanying drawings is intended as a description of example embodiments of the present disclosure and is not intended to represent all embodiments.

Specific terms used in the various example embodiments are provided only to help understanding of the present disclosure, and use of the specific terms may be modified in a different form without departing from the technical spirit of the present disclosure.

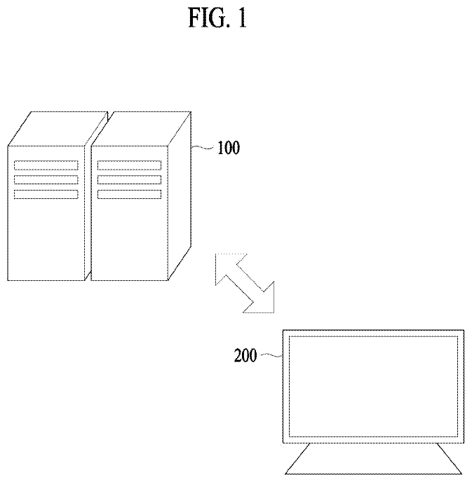

FIG. 1 is a diagram illustrating an order-related information providing system in which an operating method of an electronic apparatus for providing information related to an order may be implemented according to various example embodiments.

Referring to FIG. 1, the order-related information providing system according to various example embodiments may be implemented as various types of electronic apparatus. For example, the order-related information providing system may be implemented in a server device 100 and a device 200 interoperating with the server device 100. In other words, the server device 100 and the device 200 interoperating with the server device 100 may perform operations according to various example embodiments of the present disclosure on the basis of the order-related information providing system implemented through the server device 100. Meanwhile, the order-related information providing system according to various example embodiments is not limited to that shown in FIG. 1 and may be implemented as a wider variety of electronic apparatus and servers.

The server device 100 according to various example embodiments may be an apparatus which performs wireless and wired communication with the device 200 interoperating with the server device 100 and includes a storage having a massive storage capacity. For example, the server device 100 may be a cloud device which is linked to a device interoperating with the server device 100.

The device 200 interoperating with the server device 100 according to various example embodiments may be an apparatus, such as a desktop personal computer (PC), a tablet PC, or a mobile terminal, which interoperates with the server device 100 to output information provided by the server device 100. In addition, other electronic apparatus which perform similar functions may be used as the device 200 interoperating with the server device 100.

The order-related information providing system according to various example embodiments may include various modules for operation. The modules included in the order-related information providing system may be a computer code or one or more instructions implemented so that a physical apparatus (e.g., the server device 100) in which the order-related information providing system is implemented (or included in the physical apparatus) can perform a designated operation. In other words, the physical apparatus in which the order-related information providing system is implemented may store a plurality of modules in a memory in the form of computer code, and when the plurality of modules stored in the memory are executed, the plurality of modules may cause the physical apparatus to perform designated operations corresponding to the plurality of modules.

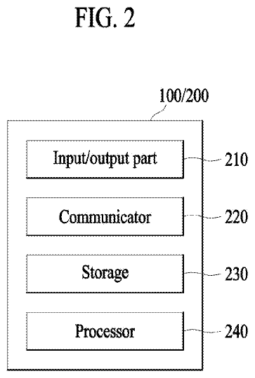

FIG. 2 is a diagram illustrating a configuration of a server device and a device interoperating with the server device according to various example embodiments.

Referring to FIG. 2, the server device 100 and the device 200 interoperating with the server device 100 may include an input/output part 210, a communicator 220, a storage 230, and a processor 240.

The input/output part 210 may be various types of interfaces or connection ports which receive a user input or output information to a user. The input/output part 210 may include an input module and an output module, and the input module receives a user input from the user. The user input may be made in various forms including a key input, a touch input, and a voice input. Examples of the input module receiving such a user input include not only a conventional keypad, keyboard, and mouse but also a touch sensor which senses the user's touch, a microphone which receives a voice signal, a camera which recognizes a gesture or the like through video recognition, a proximity sensor including at least one of an illumination sensor and an infrared sensor which senses the approach of the user, a motion sensor which recognizes the user's motion through an accelerometer, a gyro sensor, or the like, and various forms of input parts which sense or receive various other forms of user inputs. The input module according to the example embodiment of the present disclosure may include at least one of the aforementioned devices. Here, the touch sensor may be implemented as a touch panel which is attached to a display panel, a piezoelectric or capacitive touch sensor which detects a touch through a touch film, an optical touch sensor which detects a touch in an optical manner, or the like. Further, the input module may be implemented in the form of an input interface (a Universal Serial Bus (USB) port, a Personal System/2 (PS/2) port, or the like) which connects an external input device which receives a user input rather than a device for detecting a user input by itself. Also, the output module may output various kinds of information. The output module may include at least one of a display which outputs images, a speaker which outputs sound, a haptic device which generates vibrations, and various other forms of output parts. Further, the output module may be implemented in the form of a port-type output interface which connects the aforementioned individual output part.

For example, the output module in the form of a display may display text, still images, and videos. The display may include at least one of a liquid crystal display (LCD), a light-emitting diode (LED) display, an organic LED (OLED) display, a flat panel display (FPD), a transparent display, a curved display, a flexible display, a three-dimensional (3D) display, a holographic display, a projector, and various other forms of devices which may perform an image output function. Such a display may be in the form of a touch display integrated with the touch sensor of the input module.

The communicator 220 may communicate with another apparatus. Accordingly, the server device 100 and the device 200 interoperating with the server device 100 may exchange information with another apparatus through the communicator 220. For example, the server device 100 and the device 200 interoperating with the server device 100 may communicate with each other or another apparatus through the communicator 220.

Here, the communication, that is, transmission and reception of data, may be performed in a wired or wireless manner. To this end, the communicator 220 may be configured as a wired communication module which is connected to the Internet and the like through a local area network (LAN), a mobile communication module which is connected to a mobile communication network through a mobile communication base station and transmits and receives data, a short-range communication module which employs a wireless LAN (WLAN) communication method, such as Wi-Fi, or a wireless personal area network (WPAN) communication method, such as Bluetooth or ZigBee, a satellite communication module which employs a global navigation satellite system (GNSS), such as the Global Positioning System (GPS), or a combination thereof.

The storage 230 may store various kinds of information. The storage 230 may store data temporarily or semi-permanently. For example, the storage 230 of the server 100 may store an operating system (OS) for running the server 100, data for hosting a website, data of a program or application (e.g., a web application) for generating braille, and the like. Also, the storage 230 may store modules in the form of computer code as described above.

Examples of the storage 230 may include a hard disk drive (HDD), a solid-state drive (SSD), a flash memory, a read-only memory (ROM), a random-access memory (RAM), and the like. The storage 230 may be provided as an embedded type or a detachable type.

The processor 240 controls overall operations of the server device 100 and the device 200 interoperating with the server device 100. To this end, the processor 240 may compute and process various kinds of information and control operations of components of the server 100. For example, the processor 240 may execute a program or application for providing information related to an order. The processor 240 may be implemented as a computer or a similar device according to hardware, software, or a combination thereof. The processor 240 may be implemented as hardware in the form of an electronic circuit which performs a control function by processing an electrical signal and may be implemented as software in the form of a program for operating the hardware processor 240. Meanwhile, unless there is a particular mention in the following description, operations of the server device 100 and the device 200 interoperating with the server device 100 may be understood as being performed under the control of the processor 240. In other words, when the modules implemented in the above-described order-related information providing system are executed, the processor 240 may be interpreted as controlling the modules to perform the following operations of the server device 100 and the device 200 interoperating with the server device 100.

In brief, various example embodiments may be implemented in various ways. For example, various example embodiments may be implemented by hardware, firmware, software, combinations thereof, or the like.

In the case of hardware implementation, a method according to various example embodiments may be implemented by one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case of firmware or software implementation, a method according to various example embodiments may be implemented in the form of a module, a procedure, a function, and the like for performing functions or operations described below. For example, a software code may be stored in a memory and executed by the processor 240. The memory may be located in or outside the processor 240 and may exchange data with the processor 240 in various well-known ways.

Various example embodiments will be described in further detail below on the basis of the above-described technical spirit. The above descriptions may be applied to various example embodiments described below. For example, operations, functions, terms, etc. which are not defined in various example embodiments described below may be performed and described on the basis of the above descriptions.

Assuming that the server device 100 performs an operation of providing information related to an order, various example embodiments are described below. According to various example embodiments, the server device 100 or the device 200, which interoperates with the server device 100 and receives information related to an order from the server device 100, may output the information related to an order.

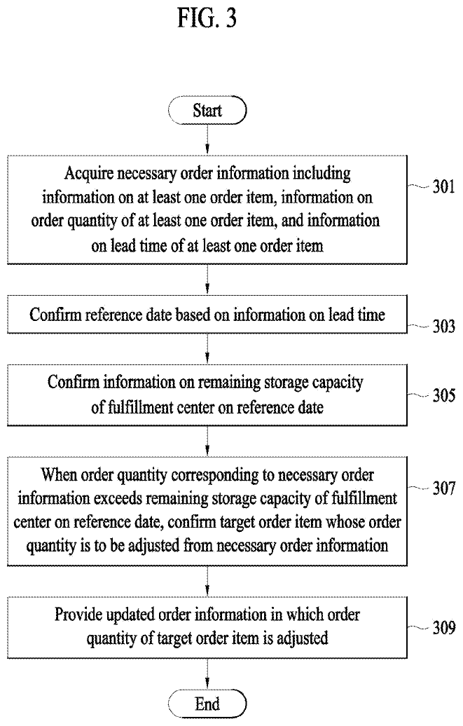

FIG. 3 is a flowchart illustrating an operating method of an electronic apparatus for providing information related to an order according to various example embodiments.

According to various example embodiments, in operation 301, the server device 100 may acquire necessary order information including information on at least one order item, information on an order quantity of the at least one order item, and information on a lead time of the at least one order item.

For example, the information acquired by the server device 100 according to operation 301 may be information received from a fulfillment center in which the at least one order item will be stocked.

For example, the information on the at least one order item may include information for identifying the at least one order item and information on a characteristic of the at least one order item. Here, the information for identifying the order item may include information on a name and image for identifying the order item, and the information on the characteristic of the order item may include information related to ordering, storage, sales, or the like of the order item such as a price and date for supplying the order item, a storage type of the order item, a selling price of the order item, whether the order item is discounted, or whether the order item is returnable.

As an example, the information related to the storage type of the order item included in the information on the characteristic of the at least one order item may include information on a storage category determined according to a storage temperature for storage of the order item. The storage category may include normal temperature, refrigerated, and frozen storage categories, and the information related to the storage type of the order item included in the information on the characteristic of the at least one order item may include information on which of the storage categories the order item is included in.

The normal temperature storage category may include order items which have no problems in maintaining the state of the order item even when the order item is kept in a storage place managed at a normal temperature or room temperature. Order items, such as general industrial products, may fall into the room temperature storage category. The refrigerated storage category may include order items whose freshness or state is difficult to maintain when the order items are kept in a storage place managed at the normal temperature or room temperature and whose freshness or state is maintained in a storage place managed at a separate refrigeration temperature. Order items, such as refrigerated fresh food or groceries, whose freshness or state should be maintained may fall into the refrigerated storage category. The frozen storage category may include order items whose freshness or state is difficult to maintain when the order items are kept in a storage place managed at the normal temperature, room temperature, or simple refrigeration temperature and whose freshness or state is maintained in a storage place managed at a separate freezing temperature. Order items, such as frozen fresh food or groceries, whose freshness or state should be maintained may fall into the frozen storage category.

For example, the information on the at least one order item may include priority information of the at least one order item. Here, the priority information of the at least one order item may include priority information of groups including the at least one order item and priority information of each of the at least one order item.

As an example, the priority information of the groups including the at least one order item may include information on groups into which the at least one order item is classified according to the priority and priority information of the groups.

Specifically, the at least one order item may be classified into a first group having a high priority, a second group having a medium priority, and a third group having a low priority. The first group having a high priority may include order items to which a price discount is applied among the at least one order item. The second group having a medium priority may include order items having a high priority among the remaining order items excluding the order items included in the first group. Here, the priority which is the base to be included in the second group may be determined according to sales volume of the order item. In other words, the second group having a medium priority may include some order items in descending order of sales volume among the remaining order items excluding the order items included in the first group. The third group having a low priority may include the remaining order items excluding the order items included in the first group and the second group.

As an example, the priority information of each of the at least one order item may include priority information according to whether each of the at least one order item is an order item for basic stock or an order item for safety stock.

Specifically, the at least one order item subjected to the information acquired by the server device 100 according to operation 301 may be classified into basic stock ordered to supply items according to sales demand and safety stock ordered to prepare for a case in which sales demand unexpectedly exceeds the supply of items. Here, the priority of an order item for basic stock may be set to be higher than that of an order item for safety stock. Also, when all of the at least one order item correspond to order items for basic stock or safety stock, the priority of the at least one order item may be determined on the basis of sales volume. In other words, when all of the at least one order item correspond to order items for basic stock or safety stock, the priority of the order item having a high sales volume may be set to be high.

The above-described priority information of the groups including the at least one order item and the above-described priority information of each of the at least one order item may be used for the server device 100 to confirm a target order item whose order quantity is to be adjusted according to operation 307 which will be described below. In other words, the at least one order item may be confirmed as a target order item whose order quantity is to be adjusted in ascending order of priority. As an example, when a first order item to a sixth order item each having a certain order quantity are ordered, a target order item whose order quantity is to be adjusted according to priority may be confirmed as follows.

The first order item and the second order item may correspond to order items to which a price discount is applied and thus belong to the first group having a high priority, the third order item and the fourth order item may correspond to order items having a high sales volume and thus belong to the second group having a medium priority, and the fifth order item and the sixth order item may belong to the third group having a low priority. Also, the first order item, the third order item, and the fifth order item may correspond to order items for basic stock, and the second order item, the fourth order item, and the sixth order item may correspond to order items for safety stock.

Under the above condition, the first group including the first order item and the second order item, the second group including the third order item and the fourth order item, and the third group including the fifth order item and the sixth order item have decreasing priorities in the order of the first group, the second group, and the third group according to the priority information of the groups including the order items. The first order item, the third order item, and the fifth order item are order items for basic stock and have a higher priority than the second order item, the fourth order item, and the sixth order item which are order items for safety stock.

Accordingly, the first order item, the second order item, the third order item, the fourth order item, the fifth order item, and the sixth order item have decreasing priorities in the order of the first order item, the second order item, the third order item, the fourth order item, the fifth order item, and the sixth order item, and a target order item whose order quantity is to be adjusted may be confirmed as the sixth order item, the fifth order item, the fourth order item, the third order item, the second order item, and the first order item in the reverse order. In this case, according to an order quantity to be adjusted, the order quantity of the order items may be adjusted in the order beginning with the sixth order item.

For example, the information on an order quantity of the at least one order item may include all order quantity information of the at least one order item. Here, the at least one order item may correspond to order items which are stocked on the same reference date. In other words, the information on the order quantity of the at least one order item may include all order quantity information of order items which are stocked together on a specific reference date.

For example, the information on the lead time of the at least one order item may include information on a lead time which is a date interval between an ordering point in time and a storage point in time which are set for the at least one order item. Here, the lead time may be set differently according to a storage characteristic of the order item or a delivery characteristic of a company which orders the item and may be set so that a deadline for sales or an expiration date of the order item does not pass.

Here, it is self-evident that various kinds of information may be combined in various forms and acquired by the server device 100 in operation 301.

According to various example embodiments, in operation 303, the server device 100 may confirm a reference date on the basis of the information on the lead time.

For example, when the lead time of the at least one order item is acquired, the server device 100 may calculate a storage date in consideration of an order date in operation 303. In other words, the date that the lead time has passed from the order date becomes the storage date, and the reference date confirmed by the server device 100 in operation 303 may be the storage date of the at least one order item. Here, the order quantity of the at least one order item to be stocked on the storage date which corresponds to the reference date may be used for the server device 100 to perform operations 305 to 309 which will be described below.

According to various example embodiments, in operation 305, the server device 100 may confirm information on a remaining storage capacity of the fulfillment center on the reference date.

For example, to confirm the information on the remaining storage capacity of the fulfillment center on the reference date, the server device 100 may receive information on a total item storage capacity of the fulfillment center, information on the amount of inventory of items currently stored in the fulfillment center, and information on a scheduled warehousing quantity of items determined to be stocked in the fulfillment center according to existing orders from the fulfillment center. In other words, the information on the remaining storage capacity of the fulfillment center on the reference date confirmed by the server device 100 in operation 305 may be confirmed on the basis of the information on the item storage capacity of the fulfillment center, the information on a current amount of inventory of items in the fulfillment center, and the information on a scheduled warehousing quantity of items to be stocked in the fulfillment center according to existing orders.

For example, to confirm the information on the remaining storage capacity of the fulfillment center on the reference date, the server device 100 may receive information on a release quantity of items, which is estimated to be delivered from the fulfillment center by the reference date, from the fulfillment center. In other words, the information on the remaining storage capacity of the fulfillment center on the reference date confirmed by the server device 100 in operation 305 may be confirmed on the basis of the estimated release quantity information by the reference date.

For example, when the server device 100 confirms a storage type of the at least one order item to be stocked on the reference date, the information on the remaining storage capacity of the fulfillment center on the reference date confirmed in operation 305 may be information on a remaining storage capacity of a storage place corresponding to the storage type in the fulfillment center.

Here, to confirm the information on the remaining storage capacity of the storage place corresponding to the storage type in the fulfillment center on the reference date, the server device 100 may receive the information on the total item storage capacity to which the storage place is to accept, the information on the amount of inventory of items currently stored in the storage place, and the information on the scheduled warehousing quantity of items determined to be stocked in the storage place according to existing orders from the fulfillment center. In other words, in the above case, the information on the remaining storage capacity of the fulfillment center on the reference date confirmed by the server device 100 in operation 305 may be confirmed on the basis of the information on the item storage capacity of the storage place in the fulfillment center corresponding to the storage type of the at least one order item, the information on the current amount of inventory of items of the storage place, and the information on the scheduled warehousing quantity of the storage place according to existing orders.

Also, to confirm the information on the remaining storage capacity of the storage place corresponding to the storage type in the fulfillment center on the reference date, the server device 100 may receive the information on the release quantity of items, which is estimated to be delivered from the storage place corresponding to the storage type by the reference date, from the fulfillment center. In other words, in the above case, the information on the remaining storage capacity of the fulfillment center on the reference date confirmed by the server device 100 in operation 305 may be confirmed on the basis of the estimated release quantity information of the storage place in the fulfillment center corresponding to the storage type of the at least one order item by the reference date.

According to various example embodiments, in operation S307, when order quantity corresponding to the necessary order information exceeds the remaining storage capacity of the fulfillment center on the reference date, the server device 100 may confirm a target order item whose order quantity is to be adjusted from the necessary order information.

For example, the order quantity corresponding to the necessary order information in operation 307 may be the order quantity of the at least one order item whose information is confirmed by the server device 100 in operation 301. In other words, the server device 100 may compare the order quantity of the at least one order item confirmed in operation 301 with the remaining storage capacity of the fulfillment center confirmed in operation 305 to confirm the target order item whose order quantity is to be adjusted on the basis of the reference date among the at least one order item.

For example, in operation S307, when order quantity corresponding to the necessary order information exceeds the remaining storage capacity of the fulfillment center on the reference date, the target order item whose order quantity is to be adjusted confirmed by the server device 100 may be confirmed on the basis of the priority information included in the information on the at least one order item. In other words, operation 307 in which the server device 100 confirms the target order item whose order quantity is to be adjusted from the necessary order information may include an operation of confirming the target order item whose order quantity is to be adjusted among the at least one order item on the basis of the priority information of the at least one order item acquired in operation 301.

As an example, the information on the at least one order item acquired by the server device 100 in operation 301 may include the priority information of the at least one order item, and the priority information of the at least one order item may include the priority information of the groups including the at least one order item and the priority information of each of the at least one order item.

Here, the priority information of the groups including the at least one order item may include information on the groups into which the at least one order item is classified according to the priority and the priority information of the groups.

The at least one order item may be classified into the first group having a high priority, the second group having a medium priority, and the third group having a low priority. The first group having a high priority may include order items to which a price discount is applied among the at least one order item. The second group having a medium priority may include order items having a high priority among the remaining order items excluding the order items included in the first group. Here, the priority which is the base to be included in the second group may be determined according to sales volume of order items. In other words, the second group having a medium priority may include some order items in descending order of sales volume among the remaining order items excluding the order items included in the first group. The third group having a low priority may include the remaining order items excluding the order items included in the first group and the second group.

The priority information of each of the at least one order item may include priority information according to whether each of the at least one order item is an order item for basic stock or an order item for safety stock.

The at least one order item may be classified into basic stock ordered to supply items according to sales demand and safety stock for ordered to prepare for a case in which sales demand unexpectedly exceeds the supply of items. Here, the priority of an order item for basic stock may be set to be higher than that of an order item for safety stock. Also, when all of the at least one order item correspond to order items for basic stock or safety stock, the priority of the at least one order item may be determined on the basis of sales volume. In other words, when all of the at least one order item correspond to order items for basic stock or safety stock, the priority of the order item having a high sales volume may be set to be high.

For example, operation 307 in which the server device 100 confirms the target order item whose order quantity is to be adjusted among the at least one order item on the basis of the priority information may include an operation of confirming an adjustable order quantity for the order items of the first group, the second group, and the third group related to the priority and confirming the group whose order quantity is to be adjusted and the order item of the group in ascending order of priority on the basis of an excessive order quantity calculated by comparing the confirmed adjustable order quantity and the order quantity corresponding to the necessary order information with the remaining storage capacity of the fulfillment center.

As an example, the server device 100 may confirm a target order item whose order quantity is to be adjusted in ascending order of group priority and ascending order of order item priority.

When it is necessary to adjust the excessive order quantity because order quantity corresponding to the necessary order information exceeds the remaining storage capacity of the fulfillment center on the reference date, the server device 100 may preferentially adjust an order quantity for order items of the third group. In other words, among the groups for classifying the at least one order item included in the necessary order information, the order items of the group having the lowest priority may be confirmed as the target order item whose order quantity is to be preferentially adjusted. Even in the order items of the third group, an order quantity for the order item for safety stock in the third group may be adjusted first according to an order quantity to be adjusted, and when it is necessary to additionally adjust an order quantity, an order quantity for the order item for basic stock in the third group may be subsequently adjusted. Also, among the order items in the third group, the order item which has a lower priority due to a lower sales volume may be the target order item whose order quantity is to be adjusted first.

When the excessive order quantity exceeds an adjustable order quantity for the order items of the third group, the server device 100 may adjust an order quantity for the order items of the second group which has a higher priority than the third group. In other words, when the excessive order quantity is not solved by adjusting only the order quantity for the order items of the third group, the server device 100 may also perform the same order quantity adjustment procedure for the second group. In this case, the server device 100 may additionally confirm order items of the second group, which has the lowest priority after the third group among the groups for classifying the at least one order item included in the necessary order information, as target order items whose order quantity is to be adjusted. Even in the order items of the second group, an order quantity for the order item for safety stock in the second group may be adjusted first according to an order quantity to be adjusted, and when it is necessary to additionally adjust an order quantity, an order quantity for the order item for basic stock in the second group may be subsequently adjusted. Also, among the order items in the second group, the order item which has a lower priority due to a lower sales volume may be the target order item whose order quantity is to be adjusted first.

Also, when the excessive order quantity exceeds an adjustable order quantity for the order items of the second group and the third group, the server device 100 may adjust an order quantity for the order items of the first group which has the highest priority. In other words, when the excessive order quantity is not solved by adjusting only the order quantity for the order items of the second group and the third group, the server device 100 may also perform the same order quantity adjustment procedure for the first group. In this case, the server device 100 may additionally confirm the order items of the first group, which has the highest priority among the groups for classifying the at least one order item included in the necessary order information, as target order items whose order quantity is to be adjusted. Even in the order items of the first group, an order quantity for the order item for safety stock in the first group may be adjusted first according to an order quantity to be adjusted, and when it is necessary to additionally adjust an order quantity, an order quantity for the order item for basic stock in the first group may be subsequently adjusted. Also, among the order items in the first group, the order item which has a lower priority due to a lower sales volume may be the target order item whose order quantity is to be adjusted first.

In addition, when the excessive order quantity exceeds a total adjustable order quantity for the order items of the first group, the second group, and the third group, the server device 100 may generate and provide information which indicates that it is necessary to cancel the order items.

According to various example embodiments, in operation 309, the server device 100 may provide updated order information in which the order quantity of the target order item is adjusted.

For example, the updated order information may be order information obtained by adjusting the order quantity in the necessary order information acquired by the server device 100 in operation 301.

For example, the adjusted order quantity included in the updated order information provided by the server device 100 in operation 309 may be the order quantity adjusted on the basis of operations 301 to 307 described above.

For example, the server device 100 which provides the updated order information in which the order quantity is adjusted in operation 309 may acquire change information for the remaining storage capacity of the fulfillment center according to a subsequent situation of the fulfillment center. When the server device 100 acquires change information for an increased remaining storage capacity of the fulfillment center, the server device 100 may sequentially confirm the target order items whose order quantities have been adjusted already as order items which will be reordered in a larger quantity in descending order of group priority. In other words, the server device 100 may adjust an order quantity for the order item having a low priority according to the remaining storage capacity of the fulfillment center in operations 301 to 309, but when the information on the increased remaining storage capacity of the fulfillment center is acquired additionally and subsequently, the server device 100 may confirm the order items whose order quantities have been adjusted already as target order items which will be reordered in descending order of priority.

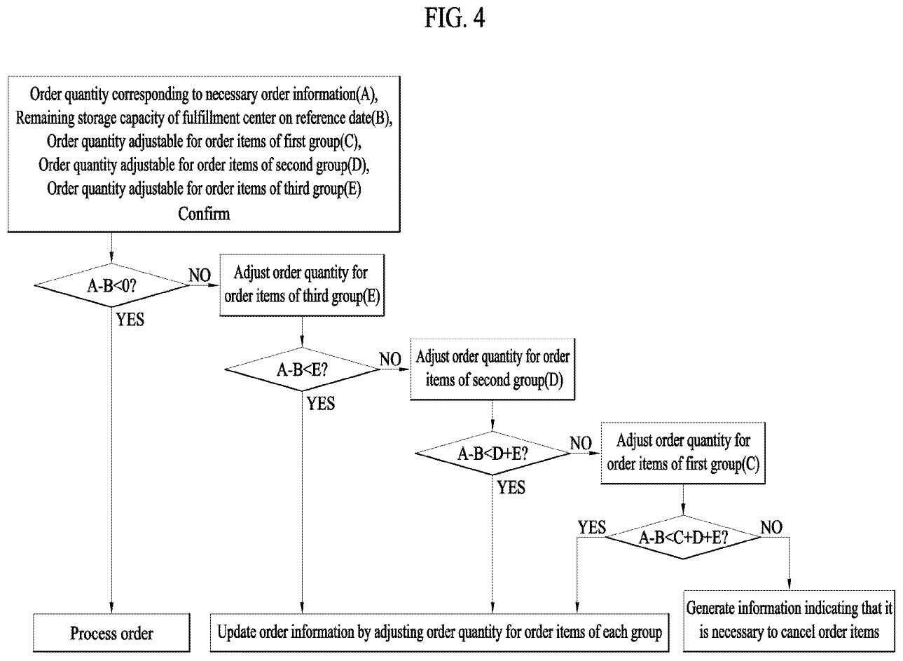

FIG. 4 is a diagram illustrating an example of a flowchart in which the server device 100 adjusts an order quantity for order items of each group according to an excessive order quantity and updates order information on the basis of the adjusted order quantity according to various example embodiments. The server device 100 may perform a procedure as shown in the flowchart of FIG. 4 on the basis of various types of information acquired to determine a target order item whose order quantity is to be adjusted and an order quantity to be adjusted for the target order item.

Referring to FIG. 4, when an order quantity corresponding to necessary order information does not exceed a remaining storage capacity of a fulfillment center on a reference date, the server device 100 may process the order on the basis of the already acquired necessary order information.

On the other hand, when order quantity corresponding to the necessary order information exceeds the remaining storage capacity of the fulfillment center on the reference date, the server device 100 may adjust an order quantity for order items of a third group which has the lowest priority. Here, when an excessive order quantity, which is calculated in consideration of the order quantity corresponding to the necessary order information and the remaining storage capacity of the fulfillment center on the reference date, is smaller than an order quantity adjustable for the order items of the third group, the server device 100 may update the order information on the basis of the order quantity for the order items of the third group adjusted according to the excessive order quantity.

When the excessive order quantity exceeds the order quantity adjustable for the order items of the third group, the server device 100 may adjust an order quantity for order items of a second group, which has the second lowest priority, in addition to the order quantity for the order items of the third group. When the excessive order quantity is smaller than the order quantities adjustable for the order items of the second group and third group, the server device 100 may update the order information on the basis of the order quantities for the order items of the second group and third group adjusted according to the excessive order quantity.

When the excessive order quantity exceeds the order quantities adjustable for the order items of the second group and third group, the server device 100 may adjust an order quantity for order items of a first group, which has the highest priority, in addition to the order quantities for the order items of the second group and third group. When the excessive order quantity is smaller than the order quantities adjustable for the order items of the first group, second group, and third group, the server device 100 may update the order information on the basis of the order quantities for the order items of the first group, second group, and third group adjusted according to the excessive order quantity.

When the excessive order quantity exceeds a total adjustable order quantity for the order items of the first group, the second group, and the third group, the server device 100 may generate information which indicates that it is necessary to cancel the order items.

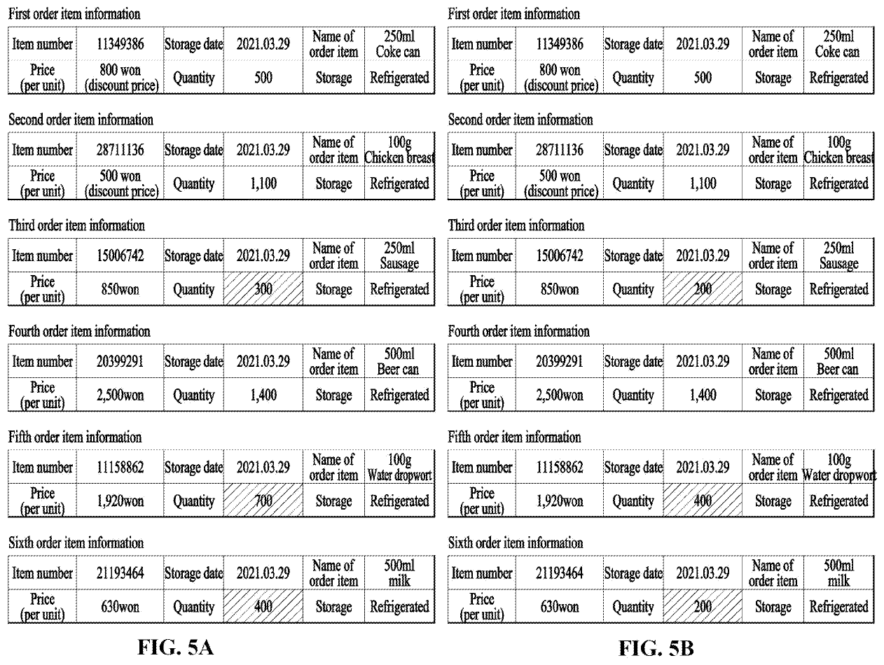

FIGS. 5A and 5B are diagrams illustrating an example of order information output on the basis of operations of the server device 100 according to various example embodiments. For example, the example of FIGS. 5A and 5B may be order information output through a user interface (Up/user experience (UX) for the server device 100 or the device 200 interoperating with the server device 100, and each of example embodiments described with reference to the drawing may be performed on the basis of the operations of the server device 100 described above with reference to FIGS. 3 and 4. However, each of the example embodiments described with reference to FIGS. 5A and 5B is not limited to such a form and may be performed in any form of implementing order information output through the UI/UX for the server device 100 or the device 200 interoperating with the server device 100.

FIGS. 5A and 5B are diagrams illustrating an example in which the server device 100 or the device 200 interoperating with the server device 100 outputs order information updated on the basis of operations of the server device 100 according to various example embodiments.

Referring to FIG. 5A, the server device 100 may acquire necessary order information including order quantities of a first order item to a sixth order item which are scheduled to be stocked in the same fulfillment center on the same storage date. Although not shown in FIG. 5A, the necessary order information acquired by the server device 100 in FIG. 5A may include various types of information, such as the characteristics, priority, lead times, or the like of the first order item to the sixth order item, which may be acquired by the server device 100 in operation 301.

In FIG. 5A, it can be seen that order quantities for the first order item to the sixth order item included in the information acquired by the server device 100 are 500, 1100, 300, 1400, 700, and 400, respectively. Accordingly, the server device 100 may confirm that a total order quantity of order items to be stocked on the same storage date is 4400.

In FIG. 5A, the first order item and the second order item are order items to which a price discount is applied and may be included in a first group having a high priority, the third order item and the fourth order item are order items having a high sales volume and may be included in a second group having a medium priority, and the fifth order item and the sixth order item are general order items and may be included in a third group having a low priority. Here, the server device 100 may determine an order quantity adjustable for order items of each group and adjust the order quantity for each order item according to the adjustable order quantity.

Referring to FIG. 5B, the server device 100 may provide order information in which the order quantities of some of the first order item to the sixth order item shown in FIG. 5A are adjusted.

In FIG. 5B, the server device 100 detects that the remaining storage capacity of the fulfillment center is smaller than 4400, which is the total order quantity of order items to be stocked on the same storage date, and adjusts a total order quantity of 700 for the third order item, the fifth order item, and the sixth order item to solve an excessive order quantity. In other words, in FIG. 5B, the server device 100 may determine the remaining storage capacity of the fulfillment center as 3700 with respect to the 4400 order items to be stocked on the same storage date and provide order information in which the total order quantity of 700 is reduced for the first order item to the sixth order item.

Here, the adjusted order quantity of 700 may be applied to some of the first order item to the sixth order item which are confirmed in order of priority. In other words, in FIG. 5B, the fifth order item and the sixth order item are order items included in the third group and may become targets of order quantity adjustment first due to the lowest priority. Accordingly, in FIG. 5B, an order quantity of each of the fifth order item and the sixth order item is adjusted to decrease by the adjustable quantity. Here, the excessive order quantity is larger than 500 which is an order quantity adjustable for order items of the third group, and thus the order quantity for the third order item of the second group having the next lowest priority is adjusted to decrease. The third order item may become a target of order quantity adjustment first in the second group because a lower priority is set to the third order item due to sales volume that is lower than that of the fourth order item belonging to the same second group.

The operation of FIGS. 5A and 5B in which order information is output through the UI/UX for the server device 100 or the device 200 interoperating with the server device 100 may be performed in connection with the operations of the server device 100 described above with reference to FIGS. 3 and 4. The UI/UX of FIGS. 5A and 5B is an example for illustrating the present disclosure. Various example embodiments of the present disclosure are not limited to the UI/UX of FIGS. 5A and 5B and may be performed according to any type of UI/UX for implementing the various example embodiments of the present disclosure.

The example embodiments of the present disclosure described with reference to the specification and the drawings are merely illustrative of specific examples to easily describe the technical content of the present disclosure and aid in understanding the present disclosure and are not intended to limit the scope of the present disclosure. In other words, it will be apparent to those of ordinary skill in the art that other modifications based on the technical spirit of the present disclosure are feasible. Also, the example embodiments may be combined with each other as necessary. For example, parts of all the example embodiments of the present disclosure may be combined with each other and implemented by a system.

Also, the method according to the present disclosure may be implemented in the form of program instructions which can be executed through various computing parts and recorded on a computer-readable medium.

As such, the various example embodiments of the present disclosure can be implemented as a computer-readable code on a computer-readable recording medium. The computer-readable recording medium may be any data storage device which can store data readable by a computer system. Examples of the computer-readable recording medium may include ROMs, RAMs, compact disk (CD)-ROMs, magnetic tapes, floppy disks, optical data storage devices, and carrier waves (data transmission over the Internet and the like). The computer-readable recording medium may be distributed over computer systems connected to a network so that the computer-readable code is stored and executed in a distributed manner. Further, functional programs, code, and code segments for achieving the various example embodiments of the present disclosure may be easily construed by programmers skilled in the field to which the present disclosure is applied.

The apparatus and method according to the various example embodiments of the present disclosure can be implemented in the form of hardware, software, or a combination of hardware and software. Such software may be recorded in volatile or non-volatile storage devices, such as ROMs, memories, such as RAMs, memory chips, memory devices, or integrated circuits, or machine (e.g., computer)-readable storage media which are optically or magnetically recordable, such as CDs, digital versatile disks (DVDs), magnetic disks, or magnetic tapes. The method according to various example embodiments of the present disclosure may be implemented by a computer including a controller and a memory, a vehicle including such a memory or computer, and the like. The memory may be an example of a machine-readable storage medium which is appropriate for storing a program or programs containing instructions for implementing the example embodiments of the present disclosure.

Accordingly, the present disclosure encompasses a program containing code for implementing the apparatus or method set forth in the claims of the specification and a machine (computer or the like)-readable storage medium storing the program. The program may be electronically transferred through any media, such as communication signals transmitted through a wired or wireless connection, and the present disclosure properly includes the equivalents thereof.

Although the present disclosure has been described above with reference to the example embodiments, the example embodiments disclosed in the specification and drawings are merely presented to easily describe technical content of the present disclosure and help understanding of the present disclosure and are not intended to limit the scope of the present disclosure. Also, the above-described example embodiments of the present disclosure are merely exemplary, and those of ordinary skill in the art would understand that various modifications and equivalents can be made from the example embodiments. Therefore, the technical scope of the present disclosure should be defined by the following claims.

What is claimed is:

1. A method of providing information related to an order by an electronic apparatus, the method comprising:
acquiring necessary order information including information on at least one order item, information on an order quantity of the at least one order item, and information on a lead time of the at least one order item;
confirming a reference date based on the information on the lead time;
confirming information on a remaining storage capacity of a fulfillment center on the reference date;
confirming a target order item whose order quantity is to be adjusted from the necessary order information when order quantity corresponding to the necessary order information exceeds the remaining storage capacity of the fulfillment center on the reference date; and
providing updated order information in which the order quantity of the target order item is adjusted.

2. The method of claim 1, wherein the information on the remaining storage capacity is confirmed based on information on an item storage capacity of the fulfillment center, information on a current amount of inventory in the fulfillment center, and information on a scheduled warehousing quantity of the fulfillment center according to existing orders.

3. The method of claim 1, wherein the information on the remaining storage capacity is confirmed based on estimated release quantity information by the reference date.

4. The method of claim 1, wherein the confirming of the information on the remaining storage capacity comprises:
confirming a storage type corresponding to the at least one order item based on the information on the at least one order item; and
confirming information on a remaining storage capacity of a storage place corresponding to the storage type in the fulfillment center.

5. The method of claim 1, wherein the confirming of the target order item whose order quantity is to be adjusted from the necessary order information comprises confirming the target order item whose order quantity is to be adjusted based on priority information included in the information on the at least one order item.

6. The method of claim 5, wherein the priority information includes information on a first group having a high priority, a second group having a medium priority, and a third group having a low priority, and
wherein the first group includes order items to which a price discount is applied among the at least one order item, the second group includes some order items having a high priority among remaining order items excluding the first group, and the third group includes remaining order items excluding the first group and the second group.

7. The method of claim 6, wherein the confirming of the target order item whose order quantity is to be adjusted based on the priority information comprises confirming a target order item of a target group whose order quantity is to be adjusted in ascending order of priority according to an excessive order quantity calculated by comparing the order quantity corresponding to the necessary order information with the remaining storage capacity of the fulfillment center.

8. The method of claim 7, wherein the target order item includes order items of the third group.

9. The method of claim 8, wherein the order items of the third group included in the target order item include an order item for basic stock and an order item for safety stock.

10. The method of claim 8, wherein the order items of the third group included in the target order item are determined based on sales volume.

11. The method of claim 8, wherein when the excessive order quantity is larger than order quantity which is adjustable for the order items of the third group, the target order item further includes order items of the second group.

12. The method of claim 11, wherein the order items of the second group included in the target order item include an order item for basic stock and an order item for safety stock.

13. The method of claim 11, wherein the order items of the second group included in the target order item are determined based on sales volume.

14. The method of claim 11, wherein when the excessive order quantity is larger than order quantity which is adjustable for the order items of the second group and the third group, the target order item further includes order items of the first group.

15. The method of claim 14, wherein the order items of the first group included in the target order item include an order item for basic stock and an order item for safety stock.

16. The method of claim 14, wherein the order items of the first group included in the target order item are determined based on sales volume.

17. The method of claim 7, the method further comprising:
acquiring change information of the remaining storage capacity; and
when the remaining storage capacity is increased according to the change information, confirming a group and an order item to be reordered among the confirmed group and the confirmed order item whose order quantity is adjusted in descending order of priority according to the increased remaining storage capacity.

18. An electronic apparatus for providing information related to an order, the electronic apparatus comprising:
a processor; and
one or more memories configured to store one or more instructions,
wherein when the one or more instructions are executed, the one or more instructions control the processor to perform operations of:
acquiring necessary order information including information on at least one order item, information on an order quantity of the at least one order item, and information on a lead time of the at least one order item;
confirming a reference date based on the information on the lead time;
confirming information on a remaining storage capacity of a fulfillment center on the reference date;
confirming a target order item whose order quantity is to be adjusted from the necessary order information when order quantity corresponding to the necessary order information exceeds the remaining storage capacity of the fulfillment center on the reference date; and
providing updated order information in which the order quantity of the target order item is adjusted.
